(19) United States
(12) Patent Application Publication
(10) Pub. No.: US 2003/0076969 A1
(43) Pub. Date: Apr. 24, 2003

(54) Two-way speaker for mobile phones

(75) Inventors: Man-Dae Han, Suwon-si (KR); Eun-Jeong Kim, Suwon-si (KR); Bok-Beum Kim, Suwon-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/044,931

(22) Filed: Jan. 15, 2002

(30) Foreign Application Priority Data
Oct. 24, 2001 (KR) 2001-65784

(51) Int. Cl. H04R 25/00; H04R 1/00; H04R 9/06; H04R 11/02

(52) U.S. Cl. 381/165; 381/396

(57) ABSTRACT

Disclosed herein is a two-way speaker for mobile phones. The two-way speaker for mobile phones includes a frame having a hollow interior and a sound output hole formed on a wall of the frame. A magnet is mounted in the hollow interior of the frame and has a first through hole communicating with the sound output hole. A top plate is mounted on the magnet and has a second through hole communicating with the first through hole of the magnet. A diaphragm having a wave form is attached to the front of the frame, and a voice coil is attached to the back surface of the diaphragm at a position adjacent to the magnet. The communicating first and second through holes and the sound output hole form an air passage ensuring a smooth circulation of air when the diaphragm is vibrated, thus accomplishing desired frequency characteristics of a receiver.

### BACKGROUND OF THE INVENTION

1. Field of the Invention

The present invention relates generally to a two-way speaker for mobile phones, and more particularly, to a two-way speaker for mobile phones, designed to use only one diaphragm, and to incorporate a speaker generating incoming sounds with a receiver regenerating voice signals.

2. Description of the Prior Art

Generally, mobile phones are all kinds of portable wireless phones, including cellular phones, PCS phones, PDA (Personal Digital Assistants), IMT-2000, and others. The mobile phones each are provided with a speaker and a receiver for transceiving characteristic signals.

The speaker is equal to the receiver in terms of both mechanical and electromagnetic properties. Both the speaker and the receiver are designed to transduce electric energy into mechanical energy by a voice coil, according to Fleming's left-hand law. Fleming's left-hand law states that a magnetic force is subject to a live conductor when the conductor is a magnetic field.

That is, when an electric signal with a variety of frequencies is sent to the voice coil, the voice coil generates mechanical energy depending on a current intensity and a frequency magnitude, and then a diaphragm attached to the voice coil is vibrated. Through this process, a sound pressure of an audible magnitude is generated.

The receiver usually generates a relatively low sound pressure, and is typically used while coming into contact with the ear when used. Contrary to the receiver, the speaker generates a relatively high sound pressure, and is typically used while being spaced apart from the ears when used.

Such speakers and receivers have not been remarkably modified in terms of their structure. But, recently, due to the abundant supply of high energy permanent magnets, the development of microstructure shaping technology, and the trend among communication devices toward small sizes as well as light weights, the communication devices having small sizes and light weights in addition to high efficiency have been widespread. Therefore, research and development for incorporating a speaker with a receiver has been actively performed.

FIG. 1 shows a conventional two-way speaker for mobile phones, incorporating a speaker with a receiver, as an example.

Referring to FIG. 1, the conventional two-way speaker for mobile phones includes a yoke 2, a magnet 3, and a top plate 4 in a frame 1. In the speaker, the yoke 2 is attached to the frame 1, and the magnet 3 and the top plate 4 are sequentially attached to the surface of the yoke 2.

A diaphragm 6 for the receiver is attached to the frame 1 in such a way as to be opposite to a diaphragm 8 for the speaker. Two voice coils 5 and 7 are attached to the diaphragms 6 and 8 at positions adjacent to the magnet 3.

Due to such a structure, when an electric current flows in the voice coil 7 attached to the diaphragm 8 for the speaker, a speaker sound is generated by the vibration of the diaphragm 8. On the other hand, when an electric current flows in the voice coil 5 attached to the diaphragm 6 for the receiver, a receiver sound is generated by the vibration of the diaphragm 6.

However, the conventional two-way speaker structured in this way has two diaphragms and two voice coils, that is, one diaphragm and one voice coil for the speaker, and one diaphragm and one voice coil for the receiver. Thus, the conventional two-way speaker for mobile phones has a problem that its productivity is poor due to complicated assembly, and the cost of product is undesirably increased.

In the prior arts, there has been proposed a method of boring the yoke, the magnet and the top plate in such a way as to be connected to each other through a caulking process, similarly to the present invention. But, the object of the conventional method is only to attach the magnet to the top plate, and is definitively different from the objects and effects of the present invention.

### SUMMARY OF THE INVENTION

Accordingly, the present invention has been made keeping in mind the above problems occurring in the prior art, and an object of the present invention is to provide a two-way speaker for mobile phones, which has an air passage in a magnetic circuit, thus functioning as a speaker as well as a receiver, with only one diaphragm and one coil.

In order to accomplish the above object, the present invention provides a two-way speaker for mobile phones, comprising a frame having a hollow interior and a sound output hole formed on a wall of the frame, a magnet mounted in the hollow interior of the frame and having a first through hole communicating with the sound output hole, a top plate mounted on the magnet and having a second through hole communicating with the first through hole of the magnet, a diaphragm having a wave form and attached to the front of the frame, and a voice coil attached to a back surface of the diaphragm at a position adjacent to the magnet, whereby the communicating first and second through holes and the sound output hole form an air passage ensuring a smooth circulation of air when the diaphragm is vibrated, thus accomplishing desired frequency characteristics of a receiver.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view showing a conventional two-way speaker for mobile phones;

FIG. 2 is a sectional view of a two-way speaker for mobile phones according to the present invention;

FIG. 3 is a front view of the two-way speaker for mobile phones of this invention; and

FIG. 4 is a rear view of the two-way speaker for mobile phones of this invention.

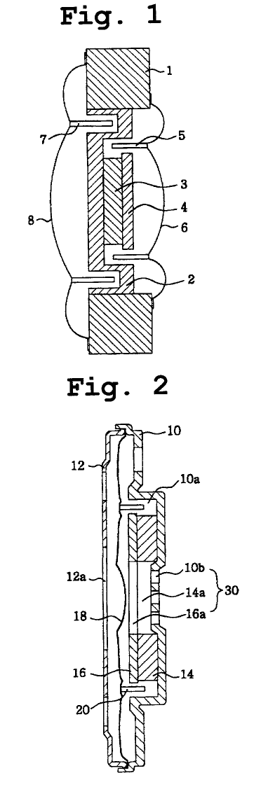

### DESCRIPTION OF THE PREFERRED EMBODIMENTS

Reference now should be made to the drawings, in which the same reference numerals are used throughout the different drawings to designate the same or similar components.

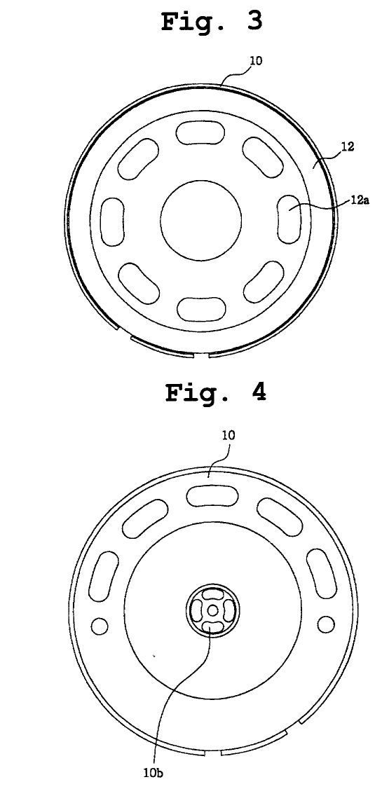

Referring to FIGS. 2, 3 and 4, speaker sound is output through the front surface of the two-way speaker according to this invention, whereas receiver sound is output through the rear surface.

According to this invention, a cap 12 is connected to the front of a frame 10. This frame 10 has a hollow interior 10a of a predetermined depth.

A plurality of sound emitting holes 12a are formed on the cap 12. A plurality of sound output holes 10b are formed on a wall of the frame 10.

A magnet 14 and a top plate 16 are received in the hollow interior 10a, and sequentially mounted therein. The magnet 14 has a first through hole 14a on its central portion, while the top plate 16 has a second through hole 16a on its central portion. In the present invention, only one through hole may be formed on the central portion of each of the magnet 14 and the top plate 16, whereas a plurality of through holes may be formed on each of them so as to meet the number of the sound output holes 10b.

It is preferable to form the first through hole 14a of the magnet 14, the second through hole 16a of the top plate 16, and the sound output hole 10b of the frame 10 in the magnetic circuit. The communicating first and second through holes 14a and 16a and the sound output hole 10b form an air passage 30.

Since such an air passage 30 ensures the smooth circulation of air in the hollow interior 10a, it accomplishes desired frequency characteristics of a receiver.

A diaphragm 18 having a wave form is attached to the front of the frame 10 at a position between the frame 10 and the cap 12. A voice coil 20 is attached to the back surface of the diaphragm 18 at a position adjacent to the magnet 14.

The operation and effect of this invention will be described in the following.

When an electric signal with a variety of frequencies is sent to the voice coil 20, the voice coil 20 generates mechanical energy by the magnetic force of the magnet 14, or a permanent magnet, depending on a current intensity and a frequency magnitude. Next, the diaphragm 18 attached to the voice coil 20 is vibrated, so a sound pressure of an audible magnitude is generated.

According to the characteristics of this invention, the air passage 30 is formed in the magnetic circuit, so the speaker sound is output from the front surface of the two-way speaker, while the receiver sound is output from the rear surface thereof, with only one diaphragm 18 and one voice coil 20.

That is, compression force or expansion force is applied to the air, by vibration of the diaphragm 18. In this case, the air passage 30 is formed in the magnetic circuit in such a way as to pass through the front and the rear surfaces of the two-way speaker, so air is smoothly circulated at the front and rear surfaces of the two-way speaker.

Thereby, air resistance is controlled in the space inside the frame 10 and the diaphragm 18, so the frequency characteristics of the front surface of the two-way speaker are equal to those of the rear surface of the two-way speaker.

That is, due to the air passage 30, the frequency characteristics of the speaker rises 2-3 dB, and the receiver of the rear surface has the same frequency characteristics as the speaker of the front surface.

As such, the present invention provides a two-way speaker for mobile phones, which functions as a speaker as well as a receiver, with only one diaphragm and one coil, thus reducing the cost of products, in addition to simplifying the manufacturing process, therefore improving productivity while producing the two-way speakers.

Furthermore, the receiver as well as the speaker possesses desired frequency characteristics, thus improving the performance of the two-way speaker.

The two-way speaker of this invention ensures the smooth circulation of air in the hollow interior, thus having a superior heat dissipating effect.

As described above, the present invention provides a two-way speaker for mobile phones, which has an air passage passing through the front and the rear surfaces thereof, and functions as a speaker as well as a receiver, with only one diaphragm and one voice coil, thus reducing the cost of two-way speakers, in addition to simplifying the manufacturing process, therefore improving productivity while producing the two-way speakers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A two-way speaker for mobile phones, comprising:
a frame having a hollow interior, with a sound output hole formed on a wall of the frame;
a magnet mounted in the hollow interior of said frame, and having a first through hole communicating with said sound output hole;
a top plate mounted on said magnet, and having a second through hole communicating with the first through hole of said magnet;
a diaphragm having a wave form, and attached to the front of said frame; and
a voice coil attached to a back surface of said diaphragm at a position adjacent to said magnet,
whereby the communicating first and second through holes and the sound output hole form an air passage ensuring a smooth circulation of air in the hollow interior when said diaphragm is vibrated, thus accomplishing desired frequency characteristics of a receiver.

2. The according to claim 1, wherein said air passage is formed in a magnetic circuit.
